(19) United States
(12) Patent Application Publication
(10) Pub. No.: US 2002/0075613 A1
(43) Pub. Date: Jun. 20, 2002

(54) Power drop out compensation circuit

(76) Inventors: Henry Hall Mason JR., Farmington, CT (US); Philip Joseph Klemas, South Windsor, CT (US)

Correspondence Address: Philmore H. Colburn II, Cantor Colburn LLP, 55 Griffin Road South, Bloomfield, CT, 06002, US

(21) Appl. No.: 09/742,151

(22) Filed: Dec. 20, 2000

(51) Int. Cl. H02H 3/00

(52) U.S. Cl. 361/42; 307/103

(57) ABSTRACT

An arc fault detection circuit includes a first resistance and an arc sensing circuit configured to sense a voltage level indicative of a voltage drop across the first resistance. The arc fault detection circuit detects an arc in the distribution circuit in response to the voltage level. A power drop out compensation circuit is configured to reduce the voltage level for a period of time after operating power is applied to the power drop out compensation circuit.

### BACKGROUND OF THE INVENTION

The present invention generally relates to circuit breakers. More particularly, the present invention relates to arc fault current interrupting (AFCI) circuit breakers.

AFCI circuit breakers are well known. These breakers comprise contacts that open upon sensing arcing from line to ground, or from line to neutral. AFCI circuit breakers typically use a differential transformer to measure arcing from line to ground. Detecting arcing from line to neutral is accomplished by detecting rapid changes in load current by measuring a voltage drop across a relatively constant resistance, usually a bi-metallic strip within the circuit breaker. Tripping of the AFCI circuit breaker occurs when a predetermined number of arcs above a certain current level are detected within a predetermined time.

A portion of a typical arc fault detection circuit is shown as 10 in Prior Art FIG. 1. The arc fault detection circuit 10 includes a temperature compensation circuit 12 that senses voltage across a bi-metal 14 and provides a temperature-compensated output voltage signal, Vₒᵤₜ, to a rectification circuit 16. Rectification circuit 16 rectifies Vₒᵤₜ, and provides the resulting signal, V_{base}, to the base of a npn-type bipolar junction transistor (BJT) 18. The collector of BJT 18 is coupled to power supply voltage, V_{cc}, and the emitter of BJT is coupled to ground via a resistance 20 and a capacitance 22, which are arranged parallel to each other. The BJT 18 along with input voltage V_{cc} and resistance 20 provide impedance matching between rectification circuit 16 and an arc sensing circuit 28, creating an output voltage, Vₚₑₐₖ. Capacitance 22 acts to stretch arc pulses. Arc sensing circuit 28 compares Vₚₑₐₖ to a threshold voltage, Vₜₕᵣₑₛₕ, to determine if an arc from line 30 to neutral has occurred. In response to the detection of an arc, circuit 28 provides a path from V_{cc} to ground via capacitance 32 and resistance 34 causing a drop in voltage at point Vᵢₙₜ. Circuit 36 senses voltage at Vᵢₙₜ and provides a trip signal to a trip solenoid (not shown) if Vᵢₙₜ falls below a reference voltage V_{ref}. The trip solenoid, in turn, causes the AFCI circuit breaker to trip.

When the power is removed from the circuit 10, Vcc and V_{ref} drop. Since Vᵢₙₜ is tied to V_{cc} by a capacitance 32, Vᵢₙₜ will drop with V_{cc}. If V_{cc} drops faster than V_{ref}, a nuisance trip can occur when Vᵢₙₜ drops below V_{ref}.

To prevent nuisance trips during power down, a resistance 38 can be coupled from the V_{ref} supply 40 to the output of the amplifier 42 in temperature compensation circuit 12. The resistance 38 increases the drop rate of V_{ref} relative to V_{cc}, and, as a result, Vᵢₙₜ is always greater than V_{ref} . Because Vᵢₙₜ is always greater than V_{ref}, the nuisance trip is prevented. For initial power up, the combination of resistance 44 and capacitance 46 provide a delay to hold the voltage at the non inverting lead of amplifier 42, V_{ref}_{_{—}}_{buf}, off until V_{cc} and V_{ref} reach operational levels. As V_{ref}_{_{—}}_{buf} rises to V_{ref}, the amplifier becomes active.

A shortcoming of the prior art solution is that the voltage V_{ref}_{_{—}}_{buf} may not be at zero when power is restored to the system. In this case, a pulse is propagated through the system that is interpreted as an arc by arc sensing circuit 28, possibly causing a nuisance trip.

### BRIEF SUMMARY OF THE INVENTION

The above discussed and other drawbacks and deficiencies of the prior art are overcome or alleviated by an arc fault detection circuit employing a power drop out compensation circuit. In an exemplary embodiment of the invention, an arc fault detection circuit includes a first resistance and an arc sensing circuit configured to sense a voltage level indicative of a voltage drop across the first resistance. The arc fault detection circuit detects an arc in the distribution circuit in response to the voltage level. A power drop out compensation circuit is configured to reduce the voltage level for a period of time after operating power is applied to the power drop out compensation circuit.

### BRIEF DESCRIPTION OF THE DRAWINGS

Referring to the exemplary drawings wherein like elements are numbered alike in the several FIGURES:

FIG. 1 is a schematic of an AFCI circuit breaker fault detection circuit of the prior art;

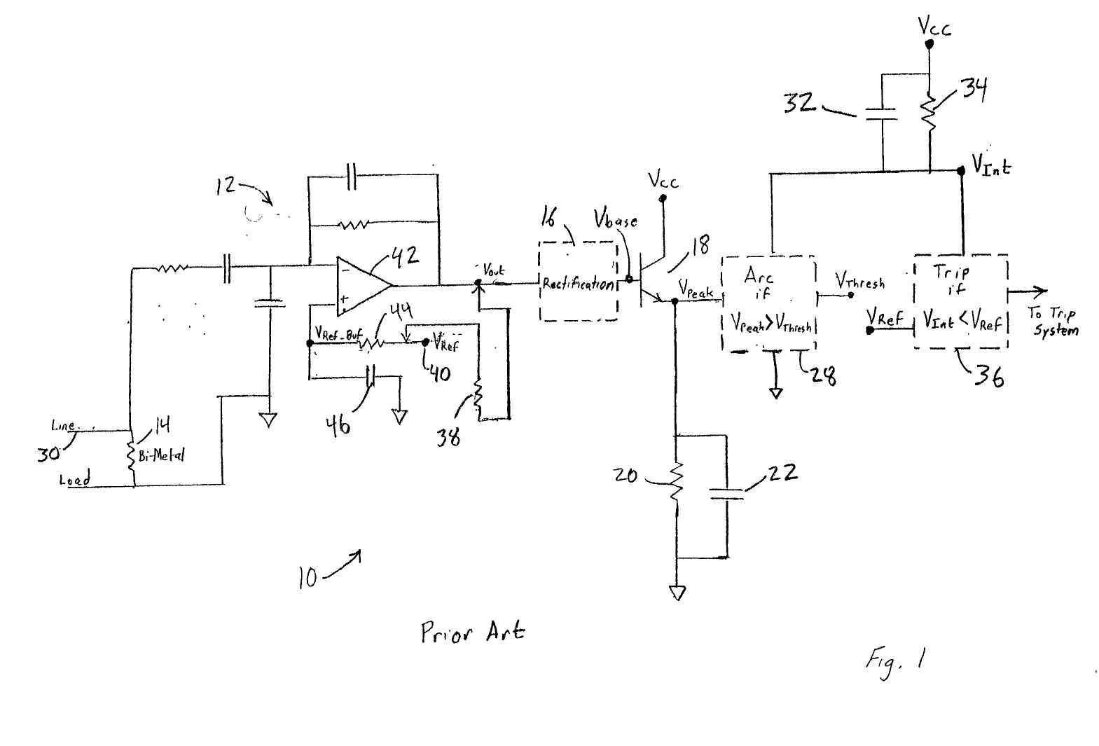

FIG. 2 is a perspective view of a mechanical compartment of an AFCI circuit breaker;

FIG. 3 is a perspective view of an electrical compartment of the AFCI circuit breaker of FIG. 2; and

FIG. 4 is a fault detection circuit of FIG. 3 with a drop out compensation circuit.

### DETAILED DESCRIPTION OF THE INVENTION

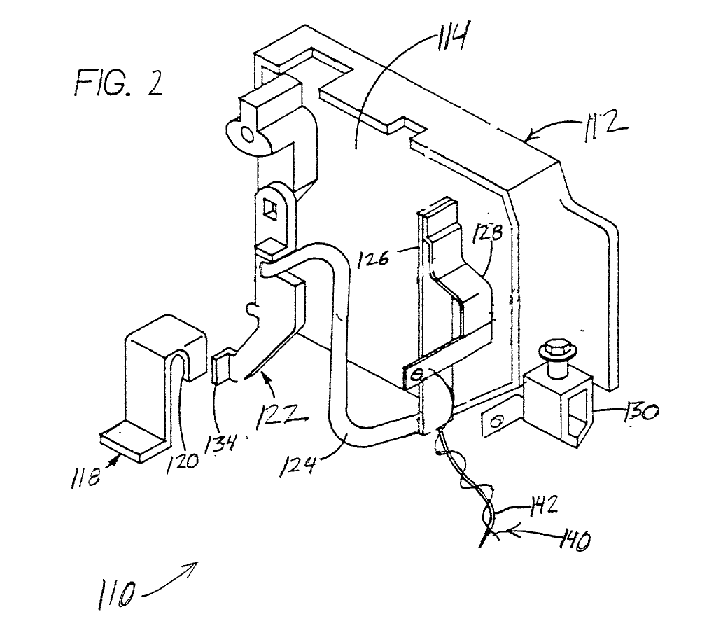

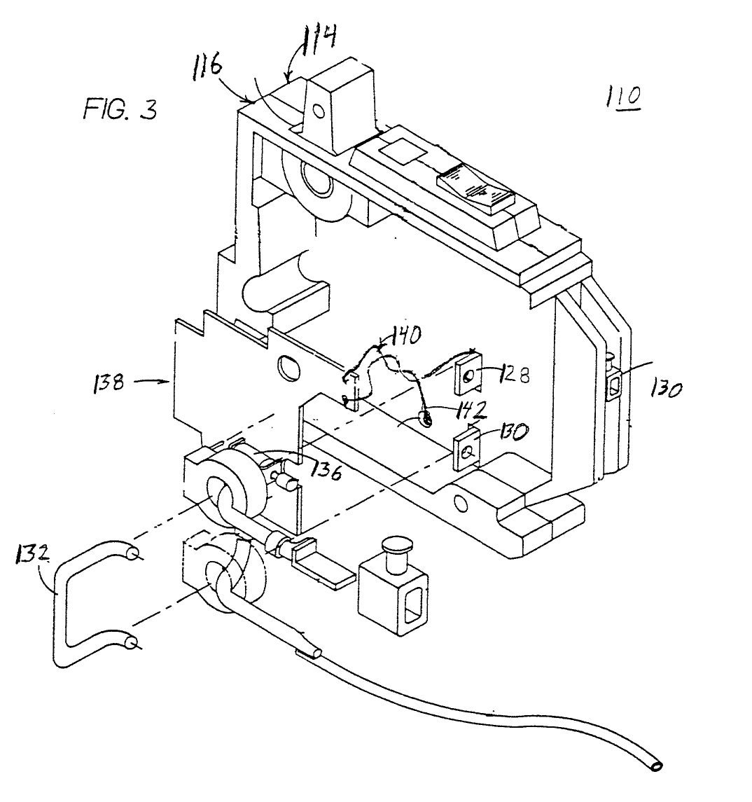

Referring to FIGS. 2 and 3, an arc fault current interrupting (AFCI) circuit breaker 110 is shown. Circuit breaker 110 includes a housing 112 with a mechanical compartment 114 and an electronics compartment 116 formed therein. Within the mechanical compartment 114, a line strap 118 is electrically coupled to an electrical distribution circuit (not shown). A stationary contact 120 is fixed to the end of the line strap 118. Rotatably secured within the mechanical compartment 114 is a movable contact arm 122. The movable contact arm 122 is electrically coupled to a flexible conductor 124, which is electrically coupled to one end of a bimetallic strip 126. The opposite end of the bimetallic strip 126 is electrically coupled to a load strap 128, which is electrically coupled to a protected portion of the electrical distribution circuit (not shown) via load lug 130 and jumper 132. Attached to the end of movable contact arm 122 is a movable contact 134. During quiescent operation of the circuit breaker 110, the fixed and movable contacts 120 and 134 are in contact with each other, allowing the flow of electrical current from the distribution circuit through the line strap 118, stationary contact 120, movable contact 134, contact arm 122, flexible connector 124, bimetallic strip 126, load strap 128, jumper 132, and load lug 130 to the protected portion of the distribution circuit.

Certain overcurrent conditions in the electrical distribution circuit will cause the bimetallic element 14 to heat up. At a predetermined temperature, the bimetallic element 14 bends, contacting a release latch (not shown) in an operating mechanism (not shown) coupled to the movable contact arm 122. When contacted by the bimetallic element 14, the release latch trips the operating mechanism, which rotates the contact arm 122 to separate the stationary and movable contacts 120 and 134. Separation of the stationary and movable contacts 120 and 134 stops the flow of electrical current to the protected portion of the distribution circuit.

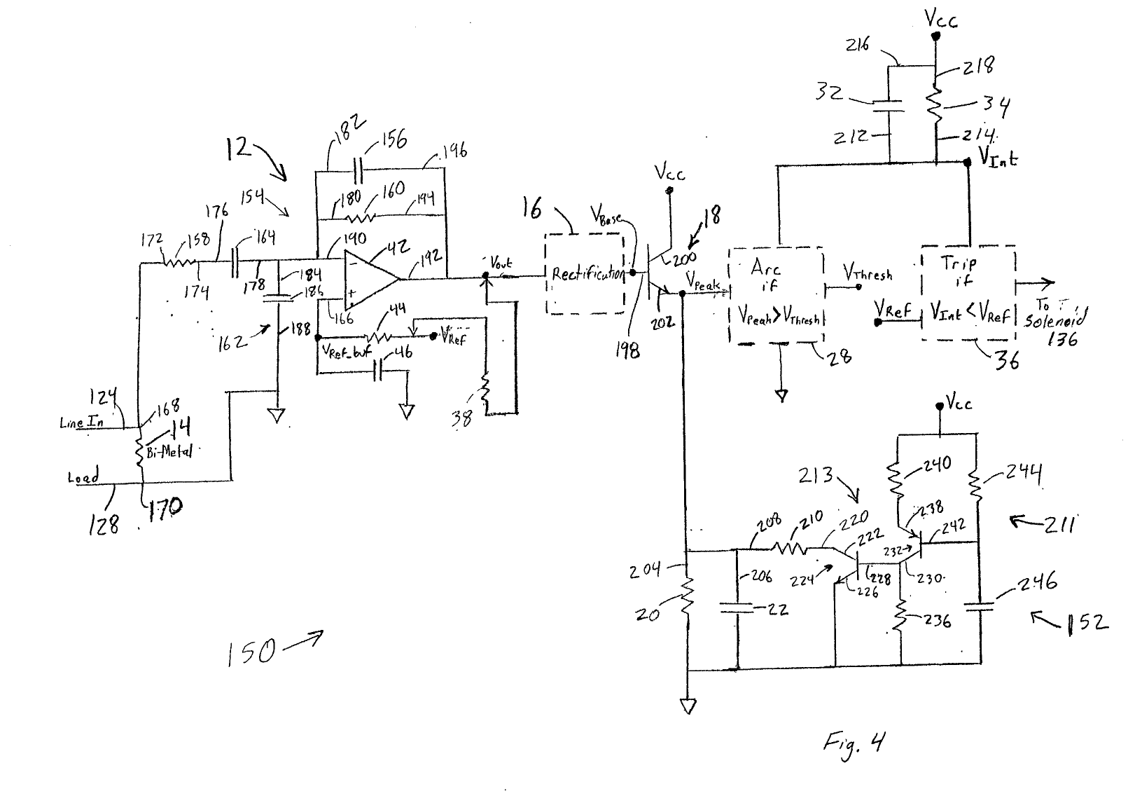

Within the electronics compartment 116 of the circuit breaker housing 112, a trip mechanism 136, such as a solenoid, is arranged to interact with the release latch of the operating mechanism (not shown). Also secured within the electronics compartment 116 is a circuit board 138, which includes arc fault detection circuitry, as is described in further detail hereinafter with reference to FIG. 4. Extending from the circuit board 138 are two wires 140 and 142. Wire 142 extends into the mechanical compartment 114 and is electrically coupled to one end of the bimetallic element 14. Wire 140 is electrically coupled to the opposite end of the bimetallic element 14 via load strap 128.

The electrical resistance of the bimetallic element 14 causes a voltage differential across wires 140 and 142 when current is passed through the bimetallic element 14 (i.e. when contacts 120 and 134 are closed). The voltage differential is sensed by the arc fault detection circuitry on circuit board 138. If the voltage differential is indicative of an arc fault, the arc fault detection circuitry provides a trip signal to the solenoid 136. In response to the trip signal, the solenoid 136 trips the operating mechanism causing the contacts 120 and 134 to separate.

Referring to FIG. 4, an arc fault detection circuit with a power drop out compensating circuit is shown at 150. It will be recognized by one skilled in the art that all or part of circuit 150 may be implemented by a microprocessor or an application-specific integrated circuit. Arc fault detection circuit 150 includes a temperature compensation circuit 12, a rectification circuit 16, a BJT 18, an arc sensing circuit 28, a trip indicating circuit 36, and a power drop out compensating circuit 152.

Temperature compensating circuit 12 includes a low pass filter 154 comprising an operational amplifier (OP-AMP) 42, feedback capacitance 156 and resistances 158 and 160. An input filter 162 filters the voltage input to the low pass filter 154, and the direct current (DC) offset of the input signal is removed by an input capacitance 164. The non-inverting lead 166 of OP-AMP 42 is coupled to reference voltage, V_{ref}, via a resistance 44. Non-inverting lead 166 is also coupled to ground via capacitance 46. The voltage at non-inverting lead 166 is indicated as V_{ref-buf}.

Bi-metal element 14 has two ends, a first end 168 and a second end 170. The second end 170 is coupled to ground. The first end 168 is coupled to a first end 172 of input resistance 158. Input resistance 158 has a positive temperature coefficient (PTC). A second end 174 of input resistance 158 is coupled to a first end 176 of input capacitance 164. The input capacitance 164 has a second end 178, which is coupled to a first end 180 of feedback resistance 160 and to a first end 182 of feedback capacitance 156. In addition, the second end 178 of the input capacitance 164 is coupled to a first end 184 of a filter capacitance 186. A second end 188 of the filter capacitance 186 is coupled to ground. Lastly, the second end 178 of the input capacitance 164 is coupled to the inverting input 190 of OP-AMP 42.

The output lead 192 of the OP-AMP 42 is coupled to rectification circuit 16. Furthermore, the output lead 192 of the OP-AMP 42 is coupled to a second end 194 of the feedback resistance 160 and to a second end 196 of feedback capacitance 156. In addition, output lead 192 of the OP-AMP 42 is coupled to V_{ref} via resistance 38.

Rectification circuit 16 rectifies the voltage signal received from the output 192 of OP-AMP 42. The output of rectification circuit 16 is provided to the base 198 of BJT 18. The voltage at base 198 is indicated as V_{base}. A collector 200 of BJT 18 is coupled to power supply voltage V_{cc}. An emitter 202 of BJT 18 is coupled to the input of arc sensing circuit 28. Emitter 202 is also coupled to a first end 204 of resistance 20, a first end 206 of capacitance 22, and a first end 208 of a resistance 210. The voltage at emitter 202 is indicated as Vₚₑₐₖ.

Arc sensing circuit 28 is coupled to a first end 212 of capacitance 32 and to a first end 214 of resistance 34. Capacitance 32 and resistance 34 are coupled in parallel, with second ends 216 and 218 of capacitance 32 and resistance 34 being coupled to supply voltage V_{cc}. The voltage at first ends 212 and 214 is indicated as Vᵢₙₜ. Arc sensing circuit 28 receives as input a threshold voltage, Vₜₕᵣₑₛₕ, integrator voltage, Vᵢₙₜ, and peak voltage Vₚₑₐₖ.

Trip indicating circuit 36 is coupled to first ends 212 and 214 of capacitance 32 and resistance 34. Trip indicating circuit 36 also receives as input V_{ref}. Trip indicating circuit 36 is coupled to trip mechanism 136 (FIG. 3).

Power drop out compensating circuit 152 is coupled to the emitter 202 of BJT 18 by first end 208 of resistance 210. Power drop out compensating circuit 152 includes a switching circuit 213 and a delay circuit 211. Switching circuit 213 includes resistance 210, an npn-type BJT 224, a pnp-type BJT 232, and resistances 240 and 236. Delay circuit 213 includes resistance 244 and capacitance 246. A second end 220 of resistance 210 is coupled to the collector 222 of npn-type BJT 224. An emitter 226 of BJT 224 is coupled to ground. A base 228 of BJT 224 is coupled to a collector 230 of pnp-type BJT 232 and to ground via resistance 236. An emitter 238 of BJT 232 is coupled to operating voltage V_{cc} via resistance 240. A base 242 of BJT 232 is coupled to V_{cc} via resistance 244, and to ground via capacitance 246.

During quiescent operation, where V_{cc} and V_{ref} are at stable operating levels, current flows from flexible conductor 124 through the bimetallic element 14 to the load strap 128. The current flowing through the bimetallic element 14 generates a voltage drop across the bimetallic element 14 because of the inherent resistance in bimetallic element 14. Input capacitance 164 eliminates any DC offset that exists in the voltage signal developed across the bimetal 14, and filter capacitance 186 removes high frequency voltage from the input signal. Feedback capacitance 156 provides high frequency negative feedback to OP-AMP 42. Resistance 160 and PTC resistance 158 provide temperature-compensated gain to OP-AMP 42. The voltage, Vₒᵤₜ, provided at output lead 192 is a filtered, temperature-compensated voltage signal indicative of voltage across bimetal 14. Rectification circuit 16 rectifies Vₒᵤₜ, and provides the resulting signal, V_{base}, to the base of BJT 18. BJT 18 along with input voltage V_{cc} and resistance 20 provide impedance matching between rectification circuit 16 and arc sensing circuit 28, creating an output voltage, Vₚₑₐₖ. Capacitance 22 acts to stretch arc pulses. Vₚₑₐₖ is provided to arc sensing circuit 28, which compares Vₚₑₐₖ to a threshold voltage, Vₜᵣₑₛₕ, to determine if an arc from line to neutral has occurred. For example, arc sensing circuit may consider an arc to have occurred when Vₚₑₐₖ is greater than Vₜᵣₑₛₕ, then this is indicative of an arc. In response to the detection of an arc, arc sensing circuit 28 provides a path from V_{cc} to ground via capacitance 32 and resistance 34, causing a drop in voltage at point Vᵢₙₜ. Trip indicating circuit 36 senses voltage at Vᵢₙₜ and provides a trip signal to the trip mechanism 136 if Vᵢₙₜ falls below a reference voltage V_{ref}. On receipt of the trip signal, the solenoid 136 separates electrical contacts 120 and 134 (FIG. 3) to stop the flow of electrical current to the protected portion of the electrical distribution circuit.

When V_{cc} is at a stable operating level (i.e., during quiescent operation), capacitance 246 of power drop out compensating circuit 152 is charged, preventing current flow through capacitance 246 to ground. In addition, with capacitance 246 fully charged, there is no current flow from base 242 of BJT 232. As a result, BJT 232 is “off”, preventing the flow of current through resistance 240, emitter 238, and collector 230 into base 228 of BJT 224. Without flow to base 228, BJT 224 is also turned off, preventing the flow of current through resistance 210, collector 222, and emitter 226 to ground. In effect, the switching circuit 213 of power drop out compensating circuit 152 opens the current path from Vₚₑₐₖ, through resistance 210 and BJT 224 to ground during quiescent operation of arc detection circuit 150.

During power down, V_{cc} and V_{ref} may drop at different rates. When V_{cc} drops, Vₒᵤₜ (DC biased to V_{ref} in OP-AMP 42) also drops. The drop in Vₒᵤₜ puts additional load on V_{ref} causing it to drop faster. Since V_{ref} (V_{ref}_{₁₃} _{buf} via resistance 44) is an input to OP-AMP 42, a small drop in V_{ref} causes a large drop in Vₒᵤₜ; consequently, V_{ref} is pulled down quickly. By increasing the drop rate of V_{ref} relative to V_{cc}, Vᵢₙₜ is always greater than V_{ref} and trip indicating circuit 36 is prevented from incorrectly sensing a trip condition during power down.

Similarly, during power up, V_{cc} and V_{ref} may increase at different rates. During power up, the combination of resistance 44 and capacitance 46 delay the application of V_{ref} to the non-inverting lead 166 of OP-AMP 42, holding OP-AMP 42 off until V_{ref} and V_{cc} reach their stable operating levels. In addition, the delay circuit 211 in power drop out compensating circuit 152 creates a delayed turn on (e.g., 28 milli-seconds) as V_{cc} ramps up. During the delay provided by resistance 244 and capacitance 246, current flows through resistance 244 and capacitance 246 to ground. In addition, current flows through resistance 240, emitter 238, and base 242 to ground, turning BJT 232 “on”. With BJT 232 on, current will flow through resistance 240, emitter 238, and collector 230 to the base 228 of BJT 224, thus turning BJT 224 “on”. With BJT 224 on, current flows from the emitter 202 of BJT 18, through resistance 210, collector 222, emitter 226, to ground. In effect, delay circuit 211 activates the switching circuit 213, shunting the current path from Vₚₑₐₖ, through resistance 210 and BJT 224 to ground for a predetermined period of time (e.g., 28 miliseconds). As a result, Vₚₑₐₖ is held close to ground during the delayed startup provided by resistance 244 and capacitance 246.

In the event that V_{ref} _{_{buf_is not zero during power up, OP-AMP 42 will be powered by the residual voltage at V}}_{ref}_{_{—}}_{buf}, and OP-AMP 42 will provide a pulse at its output, causing voltage at the base 198 of BJT 18 (V_{base}) to increase and turning BJT 18 on. In prior art arc fault detection circuits, this would cause arc sensing circuit 28 to incorrectly detect an arc, which could result in a nuisance trip. However, with power drop out compensating circuit 152, Vₚₑₐₖ is held close to ground and such nuisance trips are avoided.

After V_{cc} has reached its stable operating level, capacitance 246 of power drop out compensating circuit 152 becomes fully charged, stopping current flow from the base 242 of BJT 232 and, therefore, turning BJT 232 off. As a result, flow of current through resistance 240, emitter 238, and collector 230 into base 228 of BJT 224 is stopped. Without flow to base 228, BJT 224 is also turned off, preventing the flow of current through resistance 210, collector 222, and emitter 226 to ground. Arc fault detection circuit 150 is now in the quiescent operating condition, and Vₚₑₐₖ is now allowed to charge normally.

It will be understood that a person skilled in the art may make modifications to the preferred embodiment shown herein within the scope and intent of the claims. While the present invention has been described as carried out in a specific embodiment thereof, it is not intended to be limited thereby but intended to cover the invention broadly within the scope and spirit of the claims.

What is claimed is:

1. An arc fault detection circuit for detecting arc faults in a distribution circuit, the arc fault detection circuit comprising:
a first resistance;
an arc sensing circuit configured to sense a voltage level indicative of a voltage drop across said first resistance and detect an arc in the distribution circuit in response to the voltage level; and
a power drop out compensation circuit configured to reduce said voltage level for a period of time after operating power is applied to said power drop out compensation circuit.

2. The arc fault detection circuit of claim 1, further comprising:
a trip indicating circuit configured to provide a trip signal in response to detection of an arc by said arc sensing circuit.

3. The arc fault detection circuit of claim 1, wherein said power drop out compensation circuit includes:
a switching circuit electrically connected between a ground and a point between said first resistance and said arc sensing circuit; and
a delay circuit electrically connected to said switching circuit, said delay circuit is configured to activate said switching circuit.

4. The arc fault detection circuit of claim 3, wherein said switching circuit comprises a first transistor including:
a first collector electrically connected to said point between said first resistance and said arc sensing circuit;
a first emitter electrically connected to said ground; and
a first base electrically connected to said delay circuit.

5. The arc fault detection circuit of claim 4, wherein said switching circuit further comprises a second transistor including:
a second collector electrically connected to said first base;
a second emitter configured to receive said operating power; and
a second base electrically connected to said delay circuit.

6. The arc fault detection circuit of claim 3, wherein said delay circuit comprises:
a second resistance; and
a capacitance connected in series with said second resistance between said ground and said operating power.

7. The arc fault detection circuit of claim 5, wherein said delay circuit comprises:
a second resistance; and
a capacitance connected in series with said second resistance between said ground and said operating power, said second base is electrically connected between said second resistance and said capacitance.

8. An arc fault current interrupting circuit breaker for providing arc fault protection in a distribution circuit, the arc fault current interrupting circuit breaker comprising:
a first electrical contact;
a second electrical contact arranged proximate to said first electrical contact;
a first resistance electrically connected to said second electrical contact;
an arc sensing circuit configured to sense a voltage level indicative of the voltage drop across said first resistance and detect an arc in the distribution circuit in response to the voltage level; and
a power drop out compensation circuit configured to reduce said voltage level for a period of time after operating power is applied to said power drop out compensation circuit.

9. The arc fault current interrupting circuit breaker of claim 8, further comprising:
a trip indicating circuit configured to provide a trip signal in response to detection of an arc by said arc sensing circuit.

10. The arc fault current interrupting circuit breaker of claim 8, wherein said power drop out compensation circuit includes:
a switching circuit electrically connected between a ground and a point between said first resistance and said arc sensing circuit; and
a delay circuit electrically connected to said switching circuit, said delay circuit is configured to activate said switching circuit.

11. The arc fault current interrupting circuit breaker of claim 10, wherein said switching circuit comprises a first transistor including:
a first collector electrically connected to said point between said first resistance and said arc sensing circuit;
a first emitter electrically connected to said ground; and
a first base electrically connected to said delay circuit.

12. The arc fault current interrupting circuit breaker of claim 11, wherein said switching circuit further comprises a second transistor including:
a second collector electrically connected to said first base;
a second emitter configured to receive said operating power; and
a second base electrically connected to said delay circuit.

13. The arc fault current interrupting circuit breaker of claim 10, wherein said delay circuit comprises:
a second resistance; and
a capacitance connected in series with said second resistance between said ground and said operating power.

14. The arc fault current interrupting circuit breaker of claim 12, wherein said delay circuit comprises:
a second resistance; and
a capacitance connected in series with said second resistance between said ground and said operating power, said second base is electrically connected between said second resistance and said capacitance.

15. An arc fault detection circuit for detecting arc faults in a distribution circuit, the arc fault detection circuit comprising:
a first resistance;
an arc sensing means configured to sense a voltage level indicative of a voltage drop across said first resistance and detect an arc in the distribution circuit in response to the voltage level; and
a power drop out compensation means configured to reduce said voltage level for a period of time after operating power is applied to said power drop out compensation means.

16. The arc fault detection circuit of claim 15, further comprising:
a trip indicating means configured to provide a trip signal in response to detection of an arc by said arc sensing means.

17. The arc fault detection circuit of claim 15, wherein said power drop out compensation circuit includes:
a switching means electrically connected between a ground and a point between said first resistance and said arc sensing means; and
a delay means electrically connected to said switching means, said delay means is configured to activate said switching means.

18. The arc fault detection circuit of claim 17, wherein said switching means comprises a transistor.

19. The arc fault detection circuit of claim 17, wherein said switching means comprises an application-specific integrated circuit.

20. The arc fault detection circuit of claim 17, wherein said delay means comprises:
a second resistance; and
a capacitance connected in series with said second resistance between said ground and said operating power.

21. The arc fault detection circuit of claim 17, wherein said delay means comprises:
an application-specific integrated circuit.
